(19) United States
(12) Patent Application Publication
(10) Pub. No.: US 2026/0342455 A1
(43) Pub. Date: Oct. 29, 2026

(54) METHOD AND TRANSCEIVER FOR DETERMINING THE CFO AND INTERFERENCE

(71) Applicant: Lambda:4 Entwicklungen GmbH, Hamburg (DE)

(72) Inventor: Rönne REIMANN, Hamburg (DE)

(73) Assignee: Lambda:4 Entwicklungen GmbH, Hamburg (DE)

(21) Appl. No.: 19/653,269

(22) Filed: Apr. 21, 2026

(30) Foreign Application Priority Data
Apr. 23, 2025 (DE) 102025115624.7
Aug. 12, 2025 (EP) 25195466.5

(51) Int. Cl. H04B 17/21; H04B 17/373

(52) U.S. Cl. CPC H04B 17/21; H04B 17/373

(57) ABSTRACT

A method for determination of the CFO and signal transmission interference. The CFO is determined accurately and simply, to correct effects, detect interference, or transmission direction asymmetries. The method includes determining at least one discrepancy between the frequencies of two transceivers, wherein the transceivers exchange at least one signal on at least two different frequencies. The transmission of the at least one signal between the transmitter and receiver per direction is carried out on at least two different frequencies, one after another via at least two antenna paths, wherein switching between the at least two antenna paths is carried out at a constant frequency, with at least one pair of phase differences being formed per direction and per frequency and second differences being formed from the at least two pairs, and the at least one discrepancy is determined from the second differences by means of averaging or regression.

### TECHNICAL FIELD

The invention relates to the determination of the CFO and signal transmission interference.

### BACKGROUND ART

Numerous methods are known for determining and correcting the carrier frequency offset (CFO) and for detecting interference. Although the subject has been widely discussed in theory, it frequently poses problems in practice as reliable measurements of the one-way channel response, the distance and/or the orientation between two or more transceivers—typically in pairs—are required within a short time, in particular under 500 ms, in the face of changing and complex environments as well as restricted, imprecise and/or varying hardware resources.

The use of numerous frequencies and a plurality of antenna paths for this purpose is also known. Furthermore, methods for detecting, and in particular continuously tracking, the CFO are known, in order to minimise and/or correct the effects of the CFO on the measurements.

In the case of OFDM, for example, there is a fundamental requirement for a CF accuracy of +−20 ppm. For current uses in the MHz and GHz range, however, this is far from sufficient to meet present-day requirements, so that numerous methods are known for achieving smaller CFOs, such as coarse and fine correction and pilot tracking, for example in Paul Moose's “A Technique for Orthogonal Frequency Division Multiplexing Frequency Offset Correction”, 1994.

### SUMMARY OF THE INVENTION

Most methods for achieving high accuracy require a preliminary coarse correction or multistage correction to avoid ambiguities. This is also the case with the present invention, which prefers an additional coarse correction of the CFO to avoid ambiguities when carrying out the method.

As the inventor has recognized, oscillating circuits of transceivers, in particular PLLs, typically exhibit a behaviour in which, if the frequency changes, a fundamental frequency error between the frequencies is largely retained and, due to the change in the multiplication or division of the frequency, the error is scaled proportionally to the change.

Typically a PLL exhibits a first error relative to the set frequency at a first frequency and, when switching to another second frequency, this error is scaled in proportion to the ratio of the second frequency to the first frequency.

The object of the present invention is to determine the CFO accurately and simply, to correct effects and/or to detect interference and/or asymmetries in the transmission direction.

The object is achieved, among other things, by a method for determining at least one discrepancy between the frequencies of the frequency sources, in particular PLLs, of two transceivers,
whereby, in the case of at least two, in particular at least three, different frequencies, with the distance between the relevant adjacent frequencies used being preferably less than 10 MHz, the transceivers exchange at least one, in particular constant tone, signal per direction,
whereby in each case the at least one signal is transmitted by one transceiver and received by the other,
whereby the at least one signal per direction between the transmitter and receiver is transmitted on each of the at least two different frequencies, one after another, via at least two antenna paths,
whereby switching between the at least two antenna paths takes place at a constant frequency of the frequency source and, in particular, without a phase shift and/or with a phase shift that is known and/or constant and/or is only dependent on the antenna paths of the switch,
whereby the receiving transceiver carries out phase measurements on the received signal relative to its frequency source to determine at least one first phase difference (delta_Ph) between the at least two antenna paths at the relevant constant frequency of the frequency sources for the at least two different frequencies,
whereby at least one pair of phase differences is formed per direction and per frequency of the at least two different frequencies, and
second differences are formed between the two directions from the at least two pairs of signals with different directions and the same frequency, and
the second differences are used to determine the at least one discrepancy by means of averaging and/or regression.

The frequency sources are preferably set to the same frequency, and preferably even synchronised, before the method is carried out, so that the method only has to correct/detect relatively small differences, in particular of less than 20 ppm, preferably less than 5 ppm.

The different frequencies used are preferably pairs separated by a relatively short distance, preferably less than 20% of the frequency band used by the transceivers, in particular under 10 MHz, preferably under 5 MHz, but preferably span a significantly wider frequency band, in particular at least 80% of the band of the transceivers and/or of the frequency band used for the radio application.

These signals are, in particular, radio signals, in particular with frequencies over 1 GHz, and/or Bluetooth signals.

A direction must be understood, in particular, as a transmission direction from the first of the two transceivers to the second or vice versa. In this context, the signals are preferably transmitted at the current frequency of the frequency source of the transmitting transceiver.

Transmissions are preferably carried out one after another via multiple antenna paths on one frequency and at a fixed time interval in such a way that there is a fixed interval between the start of transmission via one antenna path and the start of transmission via another antenna path. This preferably also applies to the end and/or duration of the transmissions, whereby the intervals for the start, end and duration may each differ, but are preferably identical.

In particular, the chronological sequence of the exchange via the at least two antenna paths (i.e. in particular the sequence of use of the antenna paths for the exchange) between the two directions on one frequency is known, in particular identical, but between the at least two frequencies is in particular reversed, changed and/or not identical, in particular inverted. This makes it possible to differentiate better between different influences, such as CFO; transmission direction asymmetries and/or transceiver asymmetries; such as filters or different characteristics of a transceiver's transmitting and receiving amplifiers; and interference, and thus correct them or take them into account more easily.

In particular, the antenna paths used, and in particular also the sequence of their use for transmission, on a frequency for the consecutive transmissions on a frequency for the forward and return direction are the same, but are merely transmitted in the reverse radio transmission direction of the respective antenna path.

In particular, the sequence of the transmissions via the at least two antenna paths between the two directions at one frequency on the forward and return path (apart from the transmission direction of the respective antenna path) is also identical. This makes calculation of specific influences, for example different phase shifts of different antennas and/or antenna positions and/or antenna paths, particularly easy, namely by adding the phase shifts of the forward and return paths which cancel each other out as a result of the summation.

Preferably one, in particular continuous and/or constant tone, signal is transmitted via the at least two antenna paths in a first direction at a constant frequency. In particular one, in particular continuous and/or constant tone, signal and/or the same signal as in the first direction is used for the reverse transmission on the same set and/or previously synchronised frequency and/or unchanged setting of the frequency source, and, in particular, transmission carried out immediately after transmission in the first direction, via the at least two antenna paths. In particular, the frequency source frequencies are then changed to carry out transmissions on another frequency, with these transmissions being in particular identical, apart from the frequency and/or the choice and/or the sequence of the antenna paths.

Preferably, for every transmission via an antenna path on one frequency the relevant receiving transceiver carries out at least one phase measurement on the received signal against its frequency source.

In particular, the second differences are used to determine the at least one discrepancy by dividing by 2 pi and the time interval between the phase measurements to form the difference.

Advantageously, the at least one discrepancy is determined by calculating the average and/or as a function of the frequency, in particular by means of, in particular linear, regression analysis, in particular through the zero point, in particular through the tuple 0 Hz and no difference. This allows measurement errors to be compensated. Furthermore, it can be assumed that the frequency of 0 Hz is (or would be) error-free and that the discrepancy can be represented very well as a linear function starting from the zero point may, at least as a first approximation.

The at least one determined discrepancy, which is, in particular, determined as a function of the frequency, may be used for the arithmetic correction of phase measurements to eliminate the influence of the CFO on the measured phased shift; this applies in particular to phase measurement differences or cumulated forward and return phase measurements, since absolute phase offsets in these values may be arithmetically eliminated.

The method preferably includes the detection of interference of and/or asymmetries between the transmissions, in particular of the transmission directions between the transceivers, by examining corrected first and/or second differences of different transmission directions between the transceivers for differences and, in particular, using these differences as the measure of the interference and/or asymmetry, whereby the corrected first and/or second differences are obtained in particular in the same way as the first and/or second differences, but correcting the phase measurements from which the differences are obtained in order to determine the influence of the at least one discrepancy and/or asymmetry.

The method also makes it possible to detect interference and asymmetries. Where asymmetries exist, the detection of interference is preferably preceded by the calculation of the asymmetries so that they may be taken into account when detecting the interference.

In this context, asymmetries are, in particular, direction-dependent and the determination of the interference and asymmetries is preferably dependent on frequency and/or antenna paths, in particular per frequency and/or antenna path. Asymmetries are preferably stored for later use during later radio transmissions between the two transceivers and for calculations based on these transmissions, because they are, in contrast to interference, generally device pair-specific and time independent and primarily also environment independent.

A plurality of asymmetries between the transmissions of the transceivers is preferably determined by examining first differences, corrected for the influence of at least one deviation, in particular of the same frequency and antenna path, but with different directions of transmission between the transceivers for differences, and in particular these differences are used as a measure of the asymmetry, whereby the corrected first differences are obtained like the first differences but by correcting the phase measurements from which they are derived to account for the influence of the at least one discrepancy.

For the detection of interference, at least one filtered asymmetry from the plurality of asymmetries is preferably determined, in particular per frequency used and/or antenna path and/or per determined asymmetry, or at least one smoothed asymmetry response is determined for a frequency band and/or plurality of frequencies, in particular per antenna path.

The plurality of asymmetries is, in particular, compared with the at least one filtered asymmetry or with the smoothed asymmetry response, and the divergence obtained from the comparison is used as the measure for the interference.

The measure of interference can be used for weighting or exclusion of measurements for further analyses and/or for the choice of the frequencies, directions and/or antenna paths to be used for further transmissions.

### BRIEF DESCRIPTION OF THE DRAWINGS

Further advantageous embodiments are described purely for illustrative purposes using the schematic figures:

FIG. 1 shows two transceivers (initiator and reflector). Both have two antennas and one receiving and one transmitting unit. The four possible antenna paths (ap) are illustrated as blue waves.

FIG. 2 shows a possible sequence of signal transmissions, at the top by the initiator and at the bottom by the reflector, via the antenna paths (ap) 1 to 4 at a first frequency. They are received by the respective other transceiver and phase measurements are carried out.

FIG. 3 shows a possible sequence of signal transmissions in an inverted sequence to FIG. 2, at the top by the initiator and at the bottom by the reflector, via the antenna paths (ap) 4 to 1 at a second frequency. They are received by the respective other transceiver and phase measurements are carried out.

FIG. 4 shows a frequency response of the determined discrepancy and a straight line fitted to the discrepancy going through the origin. The straight line can be used as the basis for correction of the effect of the CFO.

The at least one discrepancy can be used to correct phase measurements, for example via

Ph′_{I,1,k}=Ph_{I,1,k}−2·π·IFₖ·Δt

where IF is the frequency discrepancy for frequency k, and Δt is the time between transmission and reception, and Ph is the phase measurement using the indices Transceiver, Antenna Path, Frequency, and Ph′ as the corrected phase measurement.

The phase asymmetry between the forward and return path can then be expressed as

PhAsym_{,21,k}=ΔPh′_{I,21,k}−ΔPh′_{R,21,k}

where

ΔPh′_{I,21,k}=Ph′_{I,2,k}−Ph′_{I,1,k} (first difference using corrected phase measurements)

with the indices “Transceiver” (I, R), “Antenna combination” (21, 12) of the path with the transmitting antenna number of the transceiver (1,2), and the receiving antenna number of the transceiver (2,1), frequency k.

Use of a smoothed filter on the phase asymmetry over the frequencies k results in, for example, a continuous, frequency-dependent set-point function that is generated from the actual phase asymmetry measured.

FPhAsym_{,21,k}=Filter(PhAsym_{,21,k})

A comparison can be used to identify a measure for the interference:

$${dPh}_{21 , k} = \vert \frac{{PhAsym}_{, 21 , k} - {FPhAsym}_{, 21 , k}}{{FPhAsym}_{, 21 , k}} \vert * 100$$

Interference, in particular frequency and/or antenna path-dependent interference, is preferably detected between the transmissions of the transceivers by examining a plurality of phase measurements that have been corrected to eliminate the influence of the at least one discrepancy and, in particular, a possible asymmetry and/or first and/or second differences from such corrected phase measurements, in particular the same frequency and/or antenna path, between the transceivers for differences from the expected result, whereby the corrected first differences are obtained in the same way as the first differences, but correcting the phase measurements from which the first differences are obtained and using the difference as a measure of the interference.

The expected result can, in particular, be zero or a value averaged and/or calculated from measured values and/or determined using regression analysis and/or filters. At least one measurement on at least one frequency, in particular a plurality of measured values on a plurality of frequencies, can thus, for example, be used to calculate an expected result, for example on another frequency. A regression analysis of the plurality of measured values and/or a smoothing of the plurality of measured values can also be carried out and used to determine an expected result.

If, for example, the second difference is formed using the phase measurements corrected to eliminate the change caused by the effect of the at least one discrepancy, zero can be expected in there is no interference.

If the indexes ini and ref refer to the two transceivers and the numerical indices refer to the antenna paths, then the second difference (DPH) can be formed using corrected phases/first differences (without an asterisk this would be the (original) second difference) at a frequency of the measurement of a signal on the forward and return path upon reception as

DPH=(Ph*.ini.0−Ph*.ini.1)−(Ph*.ref.0−Ph*.ref.1)

In this context, Ph* are the phase measurements (Ph) on the signal received at the respective transceiver indicated by the index, corrected to eliminate the effect of the at least one discrepancy and a possible asymmetry.

The difference between DPH and zero can then be assumed to be the measure of the interference.

A similar method can be used for amplitudes

(A*.ini.0.k/A*.ini.average)−(A*.ref.0.k/A*.ref.average)

(A*.ini.1.k/A*.ini.average)−(A*.ref.1.k/A*.ref.average)

where A* is the received amplitude corrected to eliminate a possible asymmetry and A* . . . average is the average amplitude of the measurements (for example averaged over the measured amplitudes across the chosen/measured frequencies) and F is the frequency.

In this case, two individual comparisons against zero make more sense than a summarization of the two lines in one.

Alternatively it is also possible, for example, to compare the following (one or more) against zero

(A*.ini.0.k/A*.ref.0.k)−(A*.ini.1.k/A*.ref.1.k)

(A*.ini.0.k/A*.ref.0.k)−(A.*ini.average/A*.ref.average)

(A*.ini.0.k/A*.ref.0.k)−AVE RAGE(A*.ini/A*.ref)

An, in particular smoothing, filter can also be used to take into account a frequency-dependent amplitude response of the transmission channel via

AC(n,k)=A.ini.n.k/A.ref.n.k

with the indices n for the antenna combination and k for the frequency and ini/ref for the transceiver and a smoothing filter

A*(n,k)=Filter(AC(n,k))

A measure of the interference can then be:

(AC(n,k)−A*(n,k))/A*(n,k)

A combination of phases and amplitudes is also possible for complex numbers, thus for example, with iq.ini.0.k as the iq value that is measured for the transceiver (ini) on Path 0 at frequency k as the “interference level”

Sum((iq.ini.0.k/iq.ini.1.k)−(iq.ref.0.k/iq.ref.1.k))

may be assumed, whereby a modified absolute value function may also be used, which, for example, weights i and q proportions differently.

In a preferred embodiment of the method, characteristics of the transmission between the transceivers and/or a/the arrangement of the transceivers are repeatedly determined and/or the method is repeatedly carried out, with at least one discrepancy and/or asymmetry being stored and used for subsequent determination of characteristics of the transmission between the transceivers and/or the and/or a/the arrangement of the transceivers, in particular as a first assumption before another determination, whereby such storage and/or use is carried out in particular for multiple transceiver pairs and/or for a specific transceiver pair.

If the method is repeated with different pairs and/or characteristics of transmission between the transceivers, and/or the and/or an arrangement of transceivers are repeatedly determined, with a plurality of more than two transceivers being used and alternating different pairs of transceivers being used and at least one pair of transceivers being repeatedly used, the stored values can be used again if a pair for which values were stored is used again, in particular for initialization. This enables a faster and/or more precise setting of the radio connection and/or measurement. This is the case in particular if uni-directional measured values, in particular phase measured values, i.e. in particular phase measurements on signals in only one direction, in particular to detect characteristics of the transmission between the transceivers, and/or the and/or an arrangement of transceivers are to be used, as is known, for example, from WO 2022 096 091 A1. The phase measurement can thus, for example, be corrected to eliminate the error caused by the discrepancy and/or the asymmetry may be removed from the calculation, in particular using a method according to WO 2022 096 091 A1. Particularly advantageously, the antenna path and/or frequency-specific phase shift of the receiving path and/or transmission path of each transceiver can also be determined and stored and it, or the stored values of the two transceivers of the current pairing, can then be used, also in previously unknown pairs, for, in particular inertial, correction, in particular of phase measurements on the received signal.

Particularly advantageously, after determination of the at least one discrepancy and/or asymmetry and/or interference, the at least one determined discrepancy, asymmetry and/or interference is used for correction and/or weighting when comparing the distance-dependent phase shift and signal propagation times of transmissions between the transceivers, in particular to detect relay attacks. This is known, for example, from WO 2022 096 514 A1.

The transceiver is preferably configured to carry out the method according to the invention using an identical transceiver. The inventive method is preferably carried out using at least two transceivers according to the invention.

### DETAILED DESCRIPTION

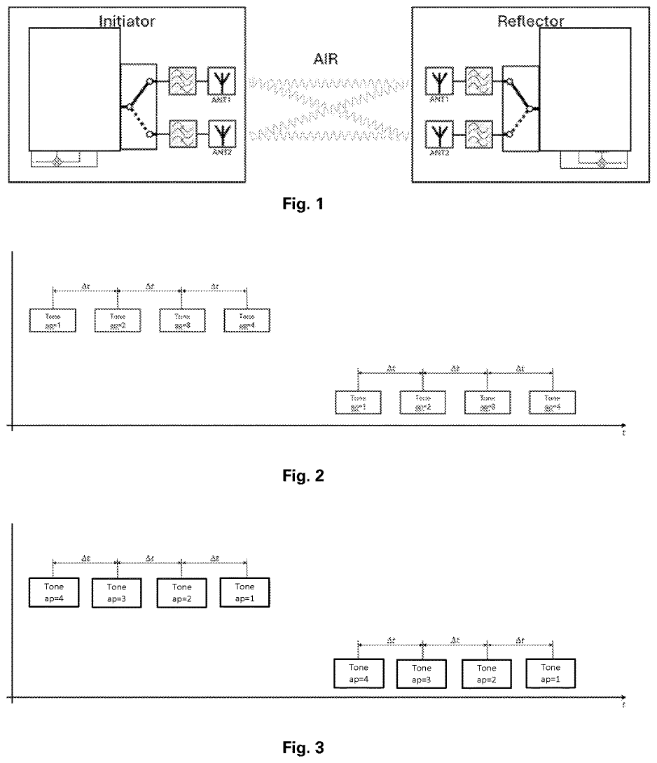

FIG. 1 shows two transceivers, an initiator and a reflector, with the air interface between them (Air). The transceivers have a receiving and a transmitting radius (in each case in the peripheral area of the figure), which may be optionally linked with either one of two antennas (ANT1, ANT2) via a contactor. Filters are installed upstream of each antenna.

The antenna paths (ap) one to four in the air interface are indicated schematically by wavy lines:

| ap | Initiator | Reflector |
|---|---|---|
| 1 | ANT1 | ANT1 |
| 2 | ANT1 | ANT2 |
| 3 | ANT2 | ANT1 |
| 4 | ANT2 | ANT2 |

FIG. 2 shows a possible sequence of signal transmissions at a frequency, first from the initiator to the reflector (top) and then from the reflector to the initiator (bottom).

The start of the transmission is indicated by a vertical line in each case. There is a constant time interval (Δt) between the lines (for transmissions by the same transceiver). Four antenna paths (ap) are used for transmission, as described for FIG. 1.

The subsequent transmissions from the reflector to the initiator take place via the same antenna paths and in the same sequence, but in the reverse transmission direction.

FIG. 3 shows transmissions from the initiator to the reflector (top) and vice versa (bottom) for another frequency with an inverted sequence of the antenna paths (ap).

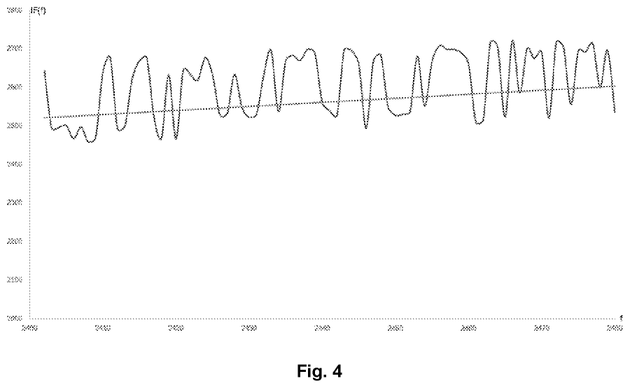

FIG. 4 shows a frequency trend of the determined discrepancy and a straight line and a straight line fitted to the discrepancy going through the origin. The straight line can be used as the basis for correction of the effect of the CFO.

What is claimed is:

1. A method for determining at least one discrepancy between the frequencies of the frequency sources of two transceivers, the method comprising:
exchanging at least one signal per direction on at least two different frequencies via the two transceivers;
wherein each case the at least one signal is transmitted by one transceiver and received by the other,
carrying out the transmission of the at least one signal between the transmitter and receiver per direction on each of the at least two different frequencies, one after another via at least two antenna paths;
wherein the switch between the at least two antenna paths is carried out at a constant frequency of the frequency sources;
carrying out respective phase measurements with the respective against its frequency source to determine at least one first phase difference between the at least two antenna paths at the respective constant frequency of the frequency sources for the at least two different frequencies,
forming at least one pair of phase differences per direction and per frequency of the at least two different frequencies;
forming second difference between the two direction with the at least two pairs of signals with different directions and the same frequency; and
determining at least one discrepancy by means of averaging or regression with the second differences.

2. The method according to claim 1, further comprising:
determining the at least one discrepancy by calculating the average or as a function of the frequency.

3. The method according to claim 1, further comprising:
correcting the phase measurements based on the at least one discrepancy that has been determined.

4. The method according to claim 1, further comprising:
detecting interference in or asymmetries between the transmissions directions between the transceivers by examining corrected first differences of different transmission directions between the transceivers or second differences based on corrected first differences for differences and using these differences as the measure of the interference or asymmetry;
obtaining the corrected first differences, like the first differences, by correcting the phase measurements from which the first differences are obtained to account for the influence of the at least one discrepancy and, in the case of the detection of interference or asymmetry.

5. The method according claim 1, further comprising:
carrying out the detection of interference between the transmissions of the transceivers by determining a plurality of asymmetries between the transmissions of the transceivers;
correcting first differences for the influence of the at least one discrepancy but with different directions of transmission between the transceivers are examined for differences and wherein the corrected first differences are obtained like the first differences but by correcting the phase measurements from which they are derived to account for the influence of the at least one discrepancy, and
whereby at least one filtered asymmetry or one smoothed asymmetry response for a frequency band and/or plurality of frequencies is determined from said plurality of asymmetries, and
said plurality of asymmetries is compared with the at least one filtered asymmetry or the smoothed asymmetry response and their difference is used as the measure of the interference, or second differences are formed using phase measurements that have been corrected to eliminate the influences of the discrepancy and the asymmetry and are used as the measure of the interference.

6. The method according to claim 1, further comprising:
detecting the interference between the transmissions of the transceivers transmissions by examining a plurality of phase measurements or first or second differences that have been corrected to eliminate the influence of the at least one discrepancy between the transceivers are examined for differences from an expected result;
wherein the corrected first or second differences, like the first or second differences, are obtained by correcting the phase measurements from which they are derived to account for the change caused by at least one of the at least one discrepancy and by the asymmetry and the divergence from the expected result is used as the measure of interference.

7. The method according to claim 1, wherein characteristics of the transmission between the transceivers or the arrangement of the transceivers are repeatedly determined; wherein at least one discrepancy or asymmetry is stored and used for subsequent determination of characteristics of the transmission between the transceivers and/or the arrangement of the transceivers; wherein such storage or use is carried out for multiple transceiver pairs or for a specific transceiver pair or wherein a determination of characteristics of the transmission between the transceivers or the arrangement of the transceivers is carried out after determination of the at least one discrepancy or asymmetry or interference based on signals between the transceivers in only one of the directions and the at least one determined discrepancy, asymmetry or interference is used to correct or weight the signals for determining transmission characteristics or the arrangement of the transceivers based on signals between the transceivers in only one of the directions.

8. The method according to claim 1, wherein following determination of the at least one discrepancy or asymmetry or interference, the method comprising:
using the at least one determined discrepancy, asymmetry or interference for correction or weighting when comparing distance-dependent phase shifts and signal propagation times of transmissions between the transceivers.

9. The method according to claim 1, further comprising:
using at least ten different frequencies or at least three different antenna paths for transmissions between the transceivers or for at least ten different frequencies or at least three different antenna paths all combinations of at least two different frequencies and at least three different antenna paths.

10. The method according to claim 1, wherein the method is carried out during phase based ranging or the detection of a one-way channel response or a one-way channel response in the frequency domain.

11. A transceiver comprising:
a frequency source; and
at least two antennas that are configured to transmit signals to another;
wherein the transceiver is on at least two different frequencies, each via the antennas via different antenna paths; receives signals from the other transceiver on at least two different frequencies, each via the antennas via different antenna paths, and is configured to determine at least one discrepancy between the frequencies of its frequency source and the frequencies of the received signals;
wherein the transceiver is configured to switch between the at least two antenna paths with a constant frequency of the frequency source;
wherein the transceiver is configured to carry out the chronological sequence of transmission and reception via the at least two antenna paths on one frequency on the at least two frequencies;
wherein the transceiver is configured to carry out phase measurements on the received signals relative to its frequency source and being configured to determine at least one first phase difference between the at least two antenna paths at a constant frequency of the frequency source for each of the at least two different frequencies; and
wherein the transceiver is configured to form at least one phase difference per frequency of the at least two different frequencies and to use this to determine the at least one discrepancy by means of averaging and/or regression.

12. The transceiver according to claim 1, configured to receive at least one phase difference per frequency of the at least two different frequencies from the other transceiver and to form differences between the pairs of phase differences of the same frequency but in a different direction and to use them to determine the at least one discrepancy by means of averaging or regression.

13. A method for detecting interference in the transmission of signals between two transceivers, with each transceiver comprising at least one frequency source, the method comprising:
exchanging at least one signal per direction with the transceivers in the case of at least two different frequencies;
transmitting the at least one signal by one signal and receiving the at least one signal by the other transceiver in each case;
wherein transmission of the at least one signal between transmitter and receiver per direction is carried out on at each of the at least two different frequencies, one after another or one after another via at least two antenna paths;
switching between the at least two antenna paths at a constant frequency of the frequency sources;
carrying out amplitude measurement via the receiving transceiver in each case to determine at least one first amplitude difference or a first amplitude ratio between the at least two directions at a constant frequency of the frequency sources and on a constant antenna path for the at least two different frequencies;
forming at least one pair of amplitude ratios between the directions per frequency or per frequency and per antenna path of the at least two different frequencies and this is used to from a frequency-dependent or frequency and antenna path-dependent amplitude set-point ratio based on smoothing;
forming the amplitude difference relative to the corresponding amplitude set-point ratio for the amplitude ratios in each case; and
comparing the result with a predetermined limit in order to assume interference if the predetermined limit is exceeded or to weight measurements, frequencies or antenna paths or frequency/antenna path combinations for which interference was detected lower than those without interference or to ignore these for further processing.

14. The method according to claim 13, further comprising:
detecting the interference or interference dependent on frequency or antenna path, between transmissions of the transceivers transmissions by examining a plurality of phase measurements or first differences—corrected for the influence of the at least one discrepancy between the transceivers and regarding the measurements for corresponding amplitude differences for divergence; and
using the divergence as the measure of an interference or wherein the chronological sequence of the exchange via the at least two antenna paths between the two directions at one frequency is identical, but is reversed between the at least two frequencies.

15. A system comprising at least two transceivers, each transceiver configured according to claim 11.

16. A system comprising at least two transceivers, each transceiver for carrying out a method according to claim 1.

17. The method according to claim 1, further comprising:
correcting the phase measurements based on the at least one discrepancy that has been determined during phase based ranging the detection of a one-way channel response between the transceivers, or
comparing the measurements of the distance-dependent phase shift and the signal propagation time measurements between the transceivers.

18. The method according to claim 1, further comprising comparing measurements of the distance-dependent phase shift and the signal propagation time measurements between the transceivers to detect relay attacks on the communication between the transceivers.

19. The method according to claim 1, wherein correction is performed for determining of a one-way channel response between the transceivers, or comparing the measurements of distance-dependent phase shift and signal propagation time measurements between the transceivers or phased based ranging.

20. The method according to claim 6, wherein the interference is dependent on frequency or antenna path or wherein the second differences that are examined for differences are of the same frequency and antenna path.

21. The method according to claim 7, wherein the at least one stored discrepancy or asymmetry is used for subsequent determination of characteristics of the transmission, as a first assumption prior to a subsequent determination.

22. The method according to claim 9, wherein the first differences or at least one second difference therefrom are determined for at least three second differences or per frequency or whereby the time interval (Δt) between switching between the antenna paths (ap), at least at a constant frequency, is the same.

23. The method according to claim 10, wherein phase based ranging or the detection of a one-way channel response is performed by uni-directional phase measurements or wherein the signals are constant tones, Bluetooth signals or channel-sounding signals.

24. The transceiver according to claim 11, wherein the transceiver is configured to carry out the chronological sequence of transmission and reception via the at least two antenna paths on one frequency in identical sequence, but reversed or inverted between the at least two frequencies.

25. The method according to claim 13, wherein the amplitude set-point ratio based on smoothing is a set of functions over the frequency or a set of functions over the frequency regarding the antenna paths or the amplitude difference relative to the corresponding amplitude set-point ratio is formed for the amplitude ratios relative to the corresponding amplitude set-point ratio.

26. The method according to claim 13, wherein divergence is determined respective an expected result or averaged curve or wherein the divergence is used as the measure of an interference or wherein the chronological sequence of the exchange via the at least two antenna paths between the two directions at one frequency is identical, but is reversed between the at least two frequencies.
